(19) United States
(12) Patent Application Publication
(10) Pub. No.: US 2019/0184675 A1
(43) Pub. Date: Jun. 20, 2019

(54) FIBER-REINFORCED FOAM MATERIAL

(71) Applicant: BASF SE, Ludwigsshafen am Rhein (DE)

(72) Inventors: Gregor DAUN, Ludwigshafen am Rhein (DE); Andreas KIRGIS, Ludwigshafen am Rhein (DE); Holger RUCKDAESCHEL, Ludwigshafen am Rhein (DE); Rene ARBTER, Ludwigshafen am Rhein (DE); Robert STEIN, Ludwigshafen am Rhein (DE); Alessio MORINO, Ludwigshafen am Rhein (DE)

(21) Appl. No.: 16/328,114

(22) PCT Filed: Aug. 22, 2017
(86) PCT No.: PCT/EP2017/071155

§ 371 Date: Feb. 25, 2019

(30) Foreign Application Priority Data
Aug. 26, 2016 (EP) 16185829.5

(51) Int. Cl. B32B 5/24; B32B 5/18; B32B 7/12; B32B 37/12; B32B 38/00; B32B 3/28; B32B 37/15

(52) U.S. Cl. CPC B32B 5/245; B32B 5/18; B32B 7/12; B32B 37/15; B32B 38/0004; B32B 3/28; B32B 37/12

(57) ABSTRACT

The present invention relates to a process for producing a fiber-foam composite (FSV1), wherein a first fiber material (FM1) is applied to a first foam body (SK1) to give a first structured fiber surface (FO1) to which a second foam body (SK2) is subsequently applied to give the fiber-foam composite (FSV1).

### CROSS-REFERENCE TO RELATED APPLICATIONS

This application is a national stage application (under 35 U.S.C. § 371) of PCT/EP2017/071155, filed Aug. 22, 2017, which claims benefit of European Application No. 16185829.5, filed Aug. 26, 2016, both of which are incorporated herein by reference in their entirety.

The present invention relates to a process for producing a fiber-foam composite (FSV1), wherein a first fiber material (FM1) is applied to a first foam body (SK1) to give an intermediate (ZP) having a first structured fiber surface (FO1) to which a second foam body (SK2) is subsequently applied to give the fiber-foam composite (FSV1).

Reinforced foams are of particular importance in the industry since they have a high strength and stiffness combined with a low weight. For this reason, reinforced foams are of particular interest for components which should be very light and nevertheless extremely mechanically stable. Thus, reinforced foams are used, for example, for components of boats and ships and also automobiles. They are also used as the core of rotor blades in wind turbines. Reinforced foams for use in such components should have good mechanical properties, in particular a high shear stiffness, preferably in three directions in space.

A foam can, for example, be reinforced by a fiber material so as to give a fiber-foam composite. Various processes for this purpose are described in the prior art.

GB 2 225 282 A describes a fiber-foam composite comprising rigid foam layers between which a reinforcing layer composed of a fiber is introduced. The rigid foam layers consist, for example, of polyetherimide foam, and the reinforcing layer consists of carbon fibers or glass fibers. The rigid foam layers are joined to the reinforcing layers by, for example, welding or adhesive bonding. GB 2 225 282 A also describes the possibility of cutting the resulting fiber-foam composites after they have been produced and adhesively bonding them together again. All fiber-foam composites described are produced from rigid foam plates which have planar surfaces. The reinforcements are thus merely one-dimensional. This type of reinforcement is disadvantageous since the fiber-foam composites do not have good mechanical properties in all three directions in space but merely in the direction in space in which the reinforcing layers have been introduced.

U.S. Pat. No. 5,866,051 describes a process for producing fiber-foam composites, wherein a foamable polymer is extruded through a nozzle and at the same time a fiber material is drawn in the extrusion direction. As a result, the fiber material is introduced into the foam. According to U.S. Pat. No. 5,866,051, it is also possible to apply the fiber material to the foam. Only planar reinforcing lauers can likewise be introduced into the foam using the process described in U.S. Pat. No. 5,866,051. Optimal reinforcement in three directions in space is therefore not possible.

WO 2005/018 926 describes various fiber-foam composites in which a fiber material has been introduced into a foam. The foams are joined to one another and to the fiber material via planar surfaces in order to produce the fiber-foam composite. WO 2005/018 926 also describes the possibility of joining trigonal-prismatically shaped foam bodies to one another via their planar surfaces, as a result of which three-dimensional reinforcement is achieved. However, a disadvantage here is that the trigonal-prismatically shaped foam bodies firstly have to be produced and wrapped with the fiber material and only then can they be joined to one another. Thus, at least three process steps (production of the trigonal-prismatically shaped foam bodies, wrapping of the foam bodies, joining of the foam bodies) are necessary, which makes the process according to WO 2005/018 926 extremely time-consuming and costly.

GB 2 188 281 relates to a fiber-foam composite composed of layers of a foam which are joined to one another via a mat, with this mat not being planar. Glass fibers, for example, are used as mat. To produce the composite, a foam having planar faces is first extruded and a plurality of elements of this foam are then laid next to one another so that they form a nonplanar layer. The impregnated mat is subsequently laid on this nonplanar layer and finally a further layer of extruded foam is placed on top. The process described in GB 2 188 281 is very complicated, and in addition the handling of the impregnated mats is problematical.

WO 2012/123551 describes a process for welding foam blocks together using wave-shaped heating elements.

EP 2 153 982 describes a foam body having welding seams which are interrupted by recesses. To produce the foam body, surfaces of foam elements are heated by means of a heating rod having a structured surface or the foam bodies have surfaces having groove-like depressions.

U.S. Pat. No. 3,902,943 describes the welding together of thermoplastic foam plates using a corrugated heating rod.

A disadvantage of the welded foams described in WO 2012/123551, EP 2 153 982 and U.S. Pat. No. 3,902,943 is that they frequently have unsatisfactory mechanical stabilities, in particular for use in components which require lightness in combination with high strength and stiffness.

It is therefore an object of the present invention to provide a process for producing a fiber-foam composite, which process does not have the abovementioned didsadvantages of the processes of the prior art or has them to a reduced extent.

This object is achieved by a process for producing a fiber-foam composite (FSV1), which comprises the following steps:
a) provision of a first foam body (SK1) which has a first structured surface (OS1),
b) provision of a first fiber material (FM1),
c) application of the first fiber material (FM1) to at least part of the first structured surfaces (OS1) of the first foam body (SK1) to give an intermediate (ZP) having a first structured fiber surface (FO1) which has the same profile as the first structured surface (OS1),
d) provision of a second foam body (SK2) which has a second structured surface (OS2) whose profile is inverse to the profile of the first structured fiber surface (FO1) of the intermediate (ZP) and
e) application of the second structured surface (OS2) of the second foam body (SK2) to at least part of the first structured fiber surface (FO1) of the intermediate (ZP) to give the fiber-foam composite (FSV1) in which the first structured fiber surface (FO1) of the intermediate (ZP) and the second structured surface (OS2) of the second foam body (SK2) are joined to one another.

### A BRIEF DESCRIPTION OF THE FIGURES

FIGS. 1A to 1D show by way of example an embodiment of the process for producing the fiber-foam composite (FSV1).

FIG. 2 shows an embodiment of the invention.

FIG. 3 shows an illustrative fiber-foam composite (FSV3; 7) which has been produced from a first foam body (SK1; 1) and five further foam bodies (SK2; SK3; 5a; 5b; 5c; 5d; 5e) and also a plurality of fiber materials 4.

The process of the invention allows cheaper and simpler production of fiber-foam composites (FSV1) than processes which have been described in the prior art.

Particular advantages of the process of the invention are that, in a preferred embodiment, the first foam body (SK1), which has a first structured surface (OS1), is provided by extrusion, thermoforming and/or wire cutting and that loss of material, which frequently occurs in the processes described in the prior art since there the foam bodies are generally subjected to cutting machining in order to produce suitably shaped foam bodies, is avoided thereby.

Since, in the process of the invention, good three-dimensional reinforcement of the foam is already achieved by the fiber-foam composite being produced by the process of the invention, additional process steps for improving the mechanical stabilization can be avoided. In addition, cutting of the fibers in the foam can be avoided since cutting and subsequent adhesive bonding, as is frequently necessary in processes described in the prior art, is not absolutely necessary in order to achieve sufficient mechanical stability.

Since the foam bodies from which the fiber-foam composite (FSV1) is produced are preferably not subjected to cutting machining, they generally have closed surfaces. This is advantageous in the further processing of the fiber-foam composites (FSV1), for example to produce panels. In the production of panels, at least one resin layer is applied to the fiber-foam composite (FSV1). When the surfaces of the foam bodies are closed, the foam bodies take up less resin. For this reason, panels which are produced from the fiber-foam composites (FSV1) of the invention are significantly lighter.

The process of the invention will be described in more detail below.

According to the invention, a first foam body (SK1) which has a first structured surface (OS1) is provided in step a).

For the purposes of the present invention, the expression “a first foam body (SK1)” encompasses both precisely one first foam body (SK1) and also two or more first foam bodies (SK1). Preference is given to precisely one foam body (SK1).

For the purposes of the present invention, “a first structured surface (OS1)” encompasses both precisely one first structured surface (OS1) and also two or more first structured surfaces (OS1).

The provision of the first foam body (SK1) can be effected by all methods known to those skilled in the art.

In the process of the invention, the first foam body (SK1) is preferably provided in step a) by extrusion, thermoforming and/or wire cutting. Particular preference is given to extrusion.

Of course, these methods can also be combined with one another.

The methods are known per se to those skilled in the art.

In the case of extrusion, a foamable polymer is usually extruded from an extruder which comprises a shaping opening and on exit from the shaping opening foams to give the first foam body (SK1). The first foam body (SK1) obtained in this way can optionally be additionally shaped by means of a calibrating tool such as a calender.

In thermoforming, which is also referred to as deep drawing or vacuum deep drawing, a polymer, usually in the form of a film or a plate, is heated, structuring is introduced by means of a shaping tool and the first foam body (SK1) is thus obtained.

In wire cutting, also referred to as wire eroding, a block of a polymer is cut by means of a hot wire and the first foam body (SK1) is obtained in this way.

The first foam body (SK1) provided in step a) preferably comprises a thermoplastic polymer. In the process of the invention, the first foam body (SK1) provided in step a) particularly preferably comprises a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyimides, polyvinyl chlorides, polyolefins, polyacrylonitriles, polyether sulfides, and copolymers and mixtures thereof.

The first foam body (SK1) can have any size.

The first foam body (SK1) has, according to the invention, a first structured surface (OS1).

For the purposes of the present invention, a “structured surface” is a surface which has depressions. The depressions are preferably arranged regularly. This means that the distance between two directly adjacent depressions is preferably substantially equal over the entire structured surface. Thus, each depression preferably has the same distance from the next adjacent depression.

The depressions are also referred to as structuring, structures, patterns or structuring patterns in the context of the present invention. For the purposes of the present invention, the depressions can also be referred to as profile.

The first structured surface (OS1) preferably has regular structuring.

The profile of the first structured surface (OS1) in step a) can have any shapes. The profile of the first structured surface (OS1) in step a) is preferably wave-shaped, zig-zag-shaped, diamond-shaped, lozenge-shaped, rectangular, square, point-like and/or grid-like.

It goes without saying that the profile or the structuring relates to the shapes of the depressions in the first structured surface (OS1) when the first structured surface (OS1) is viewed from above. In the cross section of the first foam body (SK1), the shape of the structuring of the first structured surface (OS1) can vary or deviate from the abovementioned shapes over the length of the first foam body (SK1). For example, the cross section of the structuring of the first structured surface (OS1) can be wave-shaped, zig-zag-shaped and/or crenelated.

The first structured surface (OS1) can be applied into the first foam body (SK1) by all methods known to those skilled in the art. For example, the first structured surface (OS1) can be produced during the actual process for producing the first foam body (SK1). It is also possible for the first structured surface (OS1) to be introduced, for example by means of a shaping tool, after provision of the first foam body (SK1).

Based on a right-angled coordinate system, the direction which runs perpendicular to the equalizing plane of the first structured surface (OS1) is referred to as the z direction. For the purposes of the present invention, the z direction is also referred to as thickness of the first foam body (SK1), and the two directions perpendicular thereto are the x direction and the y direction. The x direction is also referred to as length of the first foam body (SK1), and the y direction is referred to as width of the first foam body (SK1).

The first foam body (SK1) preferably additionally has a third structured surface (OS3).

For the purposes of the present invention, “a third structured surface (OS3)” encompasses both precisely one third structured surface (OS3) and two or more third structured surfaces (OS3).

The statements and preferences made/indicated above in respect of the first structured surface (OS1) apply analogously to the third structured surface (OS3).

Preference is therefore given to the profile of the third structured surface (OS3) which the first foam body (SK1) optionally has being wave-shaped, zig-zag-shaped, diamond-shaped, lozenge-shaped, rectangular, square, point-like and/or grid-like.

The profile of the third structured surface (OS3) can be identical to or different from the profile of the first structured surface (OS1). The profile of the third structured surface (OS3) is preferably identical to the profile of the first structured surface (OS1).

Preference is also given, in the process of the invention, to the first foam body (SK1) having the third structured surface (OS3), with the third structured surface (OS3) being located opposite the first structured surface (OS1).

“Opposite” means spatially opposite.

Preference is thus given to the first foam body (SK1) in the process of the invention having a third structured surface (OS3), with the third structured surface (OS3) being arranged opposite the first structured surface (OS1).

When the first foam body (SK1) has a third structured surface (OS3), preference is also given to the first structured surface (OS1) and the third structured surface (OS3) being oriented essentially parallel to one another.

For the purposes of the present invention, “essentially parallel” means that when a first equalizing plane is drawn through the first structured surface (OS1) and a second equalizing plane is drawn through the third structured surface (OS3), these two equalizing planes are at an angle of not more than ±45°, preferably not more than ±30°, more preferably not more than ±10° and most preferably not more than ±2°, to one another.

In step b), a first fiber material (FM1) is provided.

For the purposes of the present invention, “a first fiber material (FM1)” encompasses both precisely one first fiber material (FM1) and two or more first fiber materials (FM1).

All fiber materials known to those skilled in the art are in principle suitable as first fiber material (FM1) which is provided in step b). For example, the first fiber material (FM1) provided in step b) is selected from the group consisting of inorganic mineral fibers, organic fibers, natural polymers, natural organic fibers of vegetable or animal origin, carbon fibers and mixtures thereof.

Suitable inorganic mineral fibers are known to those skilled in the art. Preference is given to inorganic mineral fibers selected from the group consisting of glass fibers, basalt fibers, metal fibers, ceramic fibers and nanotube fibers.

Suitable organic fibers are likewise known to those skilled in the art. Preference is given to organic fibers selected from the group consisting of polycondensation fibers and polyaddition fibers.

Suitable natural polymers are likewise known to those skilled in the art. Preference is given to natural polymers selected from the group consisting of cellulose-based fibers, rubber fibers, starch-based fibers and glucose-based fibers.

The first fiber material (FM1) provided in step b) is therefore preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof. The first fiber material (FM1) can be provided in step b) in all forms known to those skilled in the art. The first fiber material (FM1) is preferably provided as woven fabric, lay-up, braid, nonwoven, organosheet, carded band and/or roving.

The first fiber material (FM1) provided in step b) can additionally comprise a size. Furthermore, it is possible for the first fiber material (FM1) provided in step b) to comprise a matrix material, a binder, thermoplastic fibers, powders and/or particles.

Preference is given according to the invention to the first fiber material (FM1) provided in step b) being dry. The first fiber material (FM1) is thus preferably provided dry in step b).

For the purposes of the present invention, “dry” means that the first fiber material (FM1) has not been impregnated. In particular, the first fiber material (FM1) then does not comprise any component which is to be cured, for example a resin.

In this embodiment, it is also preferred according to the invention that the first fiber material (FM1) is likewise dry on application in step c). The first fiber material (FM1) is therefore preferably applied dry to at least part of the first structured surface (OS1) of the first foam body (SK1) in step c).

Preference is therefore given, according to the invention, to a process in which
I) the first fiber material (FM1) provided in step b) is selected from the group consisting of inorganic mineral fibers, organic fibers, natural polymers, natural organic fibers of vegetable or animal origin, carbon fibers and mixtures thereof, preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof, and/or
II) the first fiber material (FM1) is provided in step b) as woven fabric, lay-up, braid, nonwoven, organosheet, carded band and/or roving, and/or
III) the first fiber material (FM1) provided in step b) comprises a size, and/or
IV) the first fiber material (FM1) provided in step b) comprises a matrix material, a binder, thermoplastic fibers, powders and/or particles.

Preference is also given to the first fiber material (FM1) being provided on rolls in step b).

In step c), the first fiber material (FM1) is applied to at least part of the first structured surface (OS1) of the first foam body (SK1) to give an intermediate (ZP) having a first structured fiber surface (FO1) which has the same profile as the first structured surface (OS1).

For the purposes of the present invention, “on at least part of the first structured surface (OS1)” means that the first fiber material (FM1) is preferably applied to from 20 to 100% of the first structured surface (OS1), preferably to from 50 to 100% of the first structured surface (OS1) and particularly preferably to from 90 to 100% of the first structured surface (OS1), in each case based on the total first structured surface (OS1).

The first fiber material (FM1) is particularly preferably applied in step c) to the entire first structured surface (OS1) of the first foam body (SK1).

In particular, the first fiber material (FM1) which is applied in step c) preferably has the same size as the surface of the first structured surface (OS1).

In a further embodiment, particular preference is given to the first fiber material (FM1) which is applied in step c) having at least the same size as the surface of the first structured surface (OS1).

For the purposes of the present invention, the “size of the surface of the first structured surface (OS1)” is the total surface of the first structured surface (OS1). It goes without saying that the surface of the first structured surface (OS1) is usually larger than the product of the width and the length of the first foam body (SK1).

When the first fiber material (FM1) is applied to the first structured surface (OS1), this means that the first fiber material (FM1) is in contact with the entire first structured surface (OS1). The first fiber material (FM1) therefore covers the entire first structured surface (OS1).

The application can be effected by all methods known to those skilled in the art. The first fiber material (FM1) is preferably applied by means of a calender in step c). Methods for this purpose are known to those skilled in the art. The calender usually presses the first fiber material (FM1) onto the first structured surface (OS1) of the first foam body (SK1).

For the purposes of the present invention, “a calender” encompasses both precisely one calender and two or more calenders.

It is possible for the first structured surface (OS1) to be, for example, heated before application of the first fiber material (FM1) to the first structured surface (OS1). Here, for example, it is possible for the first structured surface (OS1) to partially melt and the first fiber material (FM1) then to be applied. On cooling of the first structured surface (OS1), the first structured surface (OS1) is then joined to the first fiber material (FM1).

It goes without saying that, in this embodiment of the process of the invention, the first structured surface (OS1) is heated only to such an extent that the structuring is retained.

In this embodiment, joining of the first fiber material (FM1) to the first structured surface (OS1) is, for example, effected by welding. It is likewise possible for the first structured surface (OS1) to be mechanically joined to the first fiber material (FM1), for example by the molten regions of the first structured surface (OS1) intruding into pores (holes) of the first fiber material (FM1) and thereby being joined to the latter to give the first structured fiber surface (FO1).

In addition, it is possible for, for example, an adhesive and/or a solvent which partially dissolves the first structured surface (OS1) to be applied to the first structured surface (OS1) before application of the first fiber material (FM1), the first fiber material (FM1) subsequently to be applied and the join between the first fiber material (FM1) and the first structured surface (OS1) to be produced in this way.

It is also possible for the first fiber material (FM1) to be pretreated as described above for the first structured surface (OS1). It is thus also possible to heat the first fiber material (FM1) so that it becomes joined to the first structured surface (OS1) on application, and/or to apply an adhesive and/or a solvent to the first fiber material (FM1), as a result of which it becomes joined to the first structured surface (OS1) on application to the latter so as to give the first structured fiber surface (FO1).

Of course, combinations of the above-described methods are also possible.

In step c), the intermediate (ZP) having the first structured fiber surface (FO1) is obtained. The first structured fiber surface (FO1) has, according to the invention, the same profile as the first structured surface (OS1). The statements and preferences made/indicated above in respect of the first structured surface (OS1) therefore apply analogously to the profile (the structuring) of the first structured fiber surface (FO1).

Preference is therefore given to the profile of the first structured fiber surface (FO1) obtained in step c) being wave-shaped, zig-zag-shaped, diamond-shaped, lozenge-shaped, rectangular, square, point-like and/or grid-like.

Preference is also given, according to the invention, to at least the steps a) and c) being carried out in direct succession and/or to at least step a) and step c) being carried out continuously.

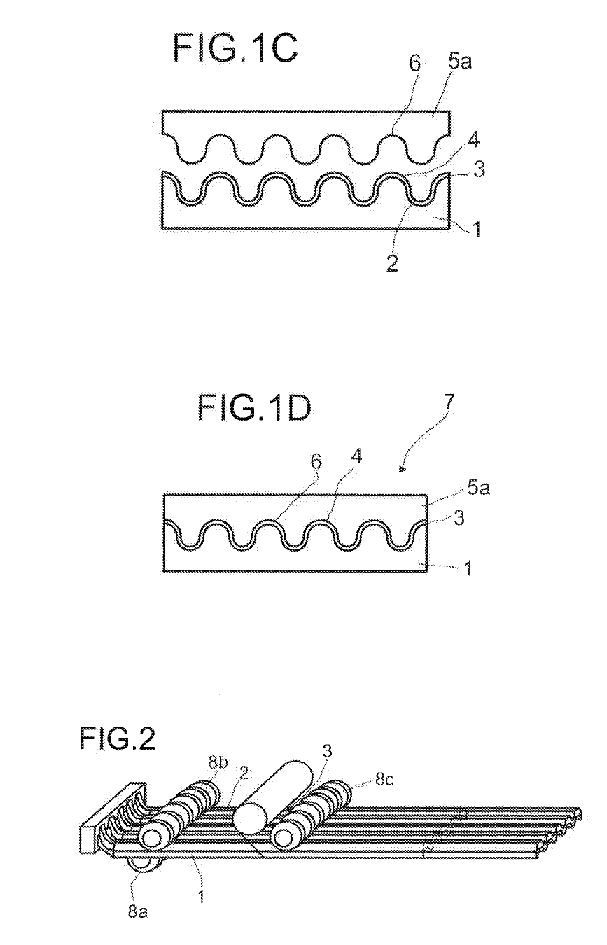

This embodiment is shown by way of example in FIG. 2. Here, the first foam body (SK1) is produced by means of extrusion. The first fiber material (FM1; 3) is applied to the first foam body (SK1; 1) immediately after extrusion of the first foam body (SK1; 1) which has a first structured surface (OS1; 2) and a third structured surface (OS3). In the embodiment depicted in FIG. 2, the first fiber material (FM1; 3) is applied in the extrusion direction to the first foam body (SK1). A calender 8c is used for applying the fiber material. The first structured surface (OS1; 2) of the first foam body (SK1; 1) is additionally formed by means of the calender 8b. The third structured surface (OS3) is additionally formed by means of the calender 8a. It is also possible in the process shown in FIG. 2 to apply the first fiber material (FM1) to the first structured surface (OS1) of the first foam body (SK1) perpendicularly to the extrusion direction.

In step d), a second foam body (SK2) which has a second structured surface (OS2) whose profile is inverse to the profile of the first structured fiber surface (FO1) of the intermediate (ZP) is provided.

For the purposes of the present invention, the expression “a second foam body (SK2)” encompasses both precisely one second foam body (SK2) and also two or more second foam bodies (SK2). Preference is given to precisely one second foam body (SK2).

For the present purposes, “inverse” means that the profile of the second structured surface (OS2) is the negative of the profile of the first structured fiber surface (FO1). This means that, viewed from the second foam body (SK2), the second structured surface (OS2) has depressions at the places at which the first structured fiber surface (FO1) has raised regions, and vice versa.

The statements and preferences made/indicated above for the first foam body (SK1) apply analogously to the second foam body (SK2). Accordingly, the statements and preferences for the first structured surface (OS1) also apply to the second structured surface (OS2).

Preference is therefore given to the second foam body (SK2) provided in step d) comprising a thermoplastic polymer, preferably a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyinnides, polyvinyl chlorides, polyolefins, polyacrylonitriles, polyether sulfides, copolymers and mixtures thereof.

In addition, the second foam body (SK2) is preferably provided in step d) by extrusion, thermoforming and/or wire cutting.

Furthermore, the profile of the second structured surface (OS2) in step d) is preferably wave-shaped, zig-zag-shaped, diamond-shaped, lozenge-shaped, rectangular, square, point-like and/or grid-like.

In addition, preference is given to the second foam body (SK2) having the third structured surface (OS3), with the third structured surface (OS3) being arranged opposite the second structured surface (OS2).

It is likewise preferred according to the invention that when the second foam body (SK2) has a third structured surface (OS3), the second structured surface (OS2) and the third structured surface (OS3) are oriented essentially parallel to one another.

For the purposes of the present invention, “essentially parallel” means that when a first equalizing plane is drawn through the second structured surface (OS2) and a second equalizing plane is drawn through the third structured surface (OS3), these two equalizing planes are at an angle of not more than ±45°, preferably not more than ±30°, more preferably not more than ±10° and most preferably not more than ±2°, to one another.

In step e), the second structured surface (OS2) of the second foam body (SK2) is applied to at least part of the first structured fiber surface (FO1) of the intermediate (ZP) to give the fiber-foam composite (FSV1). In the fiber-foam composite (FSV1), the first structured fiber surface (FO1) of the intermediate (ZP) and the second structured surface (OS2) of the second foam body (SK2) are joined to one another.

The application of the second structured surface (OS2) of the second foam body (SK2) to at least part of the first structured fiber surface (FO1) can be carried out by all methods known to those skilled in the art.

The second structured surface (OS2) of the second foam body (SK2) and/or the first structured fiber surface (FO1) of the intermediate (ZP) are preferably heated by means of a heating element before step e). The second structured surface (OS2) is subsequently applied to the first structured fiber surface (FO1).

In addition, the second structured surface (OS2) can be pressed together with the first structured fiber surface (FO1) during application.

As a result of the heating of the second structured surface (OS2) and/or the first structured surface (FO1) by means of a heating element, the second structured surface (OS2) and the first structured fiber surface (FO1) are joined to one another by a welding seam in the fiber-foam composite (FSV1) in step e).

Preference is thus given in the process of the invention to the second structured surface (OS2) of the second foam body (SK2) and/or the first structured fiber surface (FO1) of the intermediate (ZP) being heated by means of a heating element before step e) and thereby being joined to one another by a welding seam in the fiber-foam composite (FSV1) obtained in step e).

Suitable heating elements are known to those skilled in the art and are, for example, heating rods, heating grids and/or heating plates.

According to the invention, it is preferred that when the second structured surface (OS2) of the second foam body (SK2) and/or the first structured fiber surface (FO1) of the intermediate (ZP) are heated by means of a heating element before step e), heating is carried out in a contactless manner, i.e. in such a way that the heating element does not touch the second structured surface (OS2) and/or the first structured fiber surface (FO1).

In a further embodiment of the present invention, an adhesive and/or a solvent are/is applied to the second structured surface (OS2) of the second foam body (SK2) and/or to the first structured fiber surface (FO1) of the intermediate (ZP) before step e). The second structured surface (OS2) of the second foam body (SK2) is subsequently applied to the first structured fiber surface (FO1) of the intermediate (ZP). The application can optionally also be carried out with applied pressure. As a result of the application, the second structured surface (OS2) of the second foam body (SK2) and the first structured fiber surface (FO1) of the intermediate (ZP) are then joined to one another by means of the adhesive and/or the solvent in the fiber-foam composite (FSV1) obtained in step e).

Preference is thus given in the process of the invention to an adhesive and/or a solvent being applied to the second structured surface (OS2) of the second foam body (SK2) and/or to the first structured fiber surface (FO1) of the intermediate (ZP) before step e) and the second structured surface (OS2) of the second foam body (SK2) and the first structured fiber surface (FO1) of the intermediate (ZP) being joined to one another by means of the adhesive and/or the solvent in the fiber-foam composite (FSV1) obtained in step e).

If the second structured surface (OS2) of the second foam body (SK2) and the first structured fiber surface (FO1) of the intermediate (ZP) are joined to one another by means of the adhesive and/or the solvent in the fiber-foam composite (FSV1) obtained in step e), this is also referred to as “joining by adhesive bonding”.

Preference is thus given according to the invention to the second structured surface (OS2) of the second foam body (SK2) being mutually joined to at least part of the first structured fiber surface (FO1) by adhesive bonding or welding in the fiber-foam composite (FSV1) obtained in step e).

In addition, preference is given in the process of the invention to the first structured fiber surface (FO1) from step c) having the same dimensions as the second structured surface (OS2) of the second foamed body (SK2).

For the purposes of the present invention, the expression “same dimensions” means that the intermediate (ZP) has the same width and the same length as the second foam body (SK2).

In addition, the second structured surface (OS2) of the second foam body (SK2) preferably completely covers the first structured fiber surface (FO1) after step e).

In a preferred embodiment of the present invention, at least one resin is applied to the first structured fiber surface (FO1) obtained in step c) after step c) and before step e).

All resins known to those skilled in the art are suitable as the at least one resin, with preference being given to a reactive thermoset or thermoplastic resin, more preferably a resin based on epoxides, acrylates, polyurethanes, polyamides, polyesters, unsaturated polyesters, vinyl esters or mixtures thereof. The resin is particularly preferably an aminacally curing epoxy resin, a latently curing epoxy resin, an anhydrically curing epoxy resin or a polyurethane derived from isocyanates and polyols. Such resin systems are known to those skilled in the art, for example from Penczek et al., “Advances in Polymer Science, 184, pp. 1-95, 2005”, Pham et al., “Ullmann's Encyclopedia of Industrial Chemistry, Vol. 13, 2012”, Fahler, “Polyimide Kunststoffhandbuch 3/4, 1998” and Younes “WO 12 134 878”.

The at least one resin can be cured after application and before step e). It is likewise possible for the at least one resin to be cured only after the second structured surface (OS2) of the second foam body (SK2) has been applied. Methods of curing the at least one resin are known to those skilled in the art.

In one embodiment of the process of the invention, the following steps are carried out after step e):
e-i) cutting of the fiber-foam composite (FSV1) obtained in step e) at least once at an angle in the range 0°≤α≤180°, preferably at an angle in the range 45°≤α≤130° and particularly preferably at an angle α=90°, to the first fiber surface (FO1) to give a first cut fiber-foam composite having a first cut surface (OG1) and a second cut fiber-foam composite having a second cut surface (OG2),
e-ii) provision of a third fiber material (FM3),
e-iii) application of the third fiber material (FM3) to the first cut surface (OG1) of the first cut fiber-foam composite obtained in step e-i) to give a third fiber surface (FO3),
e-iv) application of the second cut surface (OG2) of the second cut fiber-foam composite obtained in step e-i) to the third fiber surface (FO3) to give a fiber-foam composite (FSV4) in which the second cut surface (OG2) is joined to the third fiber surface (FO3).

The cutting at least once in step e-i) can be carried out by all methods known to those skilled in the art. Cutting can be carried out in such a way that there is a straight cut so that a planar first cut surface (OG1) and a planar second cut surface (OG2) are obtained. In addition, it is possible for cutting to be carried out in such a way that the first cut surface (OG1) and the second cut surface (OG2) are structured. It goes without saying that the first cut surface (OG1) is in this case inverse to the second cut surface (OG2). The first cut surface (OG1) is then therefore the negative of the second cut surface (OG2).

The statements and preferences made/indicated above for the first fiber material (FM1) provided in step b) apply analogously to the third fiber material (FM3) provided in step e-ii).

It is therefore preferred that
I) the third fiber material (FM3) provided in step e-ii) is selected from the group consisting of inorganic mineral fibers, organic fibers, natural polymers, natural organic fibers of vegetable or animal origin, carbon fibers and mixtures thereof, preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof, and/or
II) the third fiber material (FM3) is provided in step e-ii) as woven fabric, lay-up, braid, nonwoven, organosheet, carded band and/or roving, and/or
III) the third fiber material (FM3) provided in step e-ii) comprises a size, and/or
IV) the third fiber material (FM3) provided in step e-ii) comprises a matrix material, a binder, thermoplastic fibers, powders and/or particles.

In addition, preference is given to the third fiber material (FM3) provided in step e-ii) being dry. The third fiber material (FM3) is thus preferably produced dry in step e-ii).

For the purposes of the present invention, “dry” means that the third fiber material (FM3) has not been impregnated. In particular, the third fiber material (FM3) then does not comprise any component which is to be cured, for example a resin.

In this embodiment, the third fiber material (FM3) is preferably applied dry to the first cut surface (OG1) in step e-iii).

The statements and preferences made/indicated above for application of the first fiber material (FM1) to the first structured surface (OS1) in step c) of the process of the invention apply analogously to the application of the third fiber material (FM3) to the first cut surface (OG1) in step e-iii).

Likewise, the statements and preferences made/indicated above for the application of the second structured surface (OS1) to the first structured fiber surface (FO1) in step e) apply analogously to the application of the second cut surface (OG2) to the third fiber surface (FO3) in step e-iv).

The fiber-foam composite (FSV4) obtained in step e-iv) comprises by the cutting of the fiber material in at least two different directions in space. It goes without saying that the fiber-foam composite (FSV4) obtained in this way can be processed further, for example by renewed cutting and renewed application of at least one fiber material. Likewise, the fiber-foam composite (FSV4) obtained can be used as fiber-foam composite (FSV1) in the step f) described below.

In addition, it is possible and preferred according to the invention to carry out the following steps after step e):
f) provision of the fiber-foam composite (FSV1) obtained in step e), where the fiber-foam composite (FSV1) has a third structured surface (OS3),
g) provision of a second fiber material (FM2),
h) application of the second fiber material (FM2) to at least part of the third structured surface (OS3) of the fiber-foam composite (FSV1) to give a fiber-foam composite (FSV2) having a second structured fiber surface (FO2) which has the same profile as the third structured surface (OS3) of the fiber-foam composite (FSV1),
i) provision of a third foam body (SK3) which has a fourth structured surface (OS4) whose profile is inverse to the profile of the second structured fiber surface (FO2) of the fiber-foam composite (FSV2) and
j) application of the fourth structured surface (OS4) of the third foam body (SK3) to at least part of the second structured fiber surface (FO2) to give a fiber-foam composite (FSV3) in which the second structured fiber surface (FO2) of the fiber-foam composite (FSV2) and the fourth structured surface (OS4) of the third foam body (SK3) are joined to one another.

Thus, the fiber-foam composite (FSV1) obtained in step e) is provided in step f), with the fiber-foam composite (FSV1) having a third structured surface (OS3).

The third structured surface (OS3) of the fiber-foam composite (FSV1) is preferably already comprised in the first foam body (SK1) which is provided in step a) and/or in the second foam body (SK2) which is provided in step d).

It is likewise possible for the third structured surface (OS3) to be applied in the fiber-foam composite (FSV1) only after the production thereof in step e) and the fiber-foam composite (FSV1) thus to be provided in step f). Methods for this purpose are known to those skilled in the art and are, for example, planing, sawing, milling and/or wire cutting.

The statements and preferences made/indicated above for the first structured surface (OS1) apply analogously to the third structured surface (OS3).

Preference is therefore given to the profile of the third structured surface (OS3) in step f) being wave-shaped, zig-zag-shaped, diamond-shaped, lozenge-shaped, rectangular, square, point-like and/or grid-like.

The statements and preferences made/indicated above for the first fiber material (FM1) apply analogously to the second fiber material (FM2) provided in step g).

It is therefore preferred in the process of the invention that
l) the second fiber material (FM2) provided in step g) is selected from the group consisting of inorganic mineral fibers, organic fibers, organic polymers, natural organic fibers of vegetable or animal origin, carbon fibers and mixtures thereof, preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof, and/or
II) the second fiber material (FM2) is provided in step g) as woven fabric, lay-up, braid, nonwoven, organosheet, carded band and/or roving, and/or
III) the second fiber material (FM2) provided in step g) comprises a size, and/or
IV) the second fiber material (FM2) provided in step b) comprises a matrix material, a binder, thermoplastic fibers, powders and/or particles.

In addition, preference is given to the second fiber material (FM2) provided in step g) being dry. The second fiber material (FM2) is thus preferably provided dry in step g).

For the purposes of the present invention, “dry” means that the second fiber material (FM2) has not been impregnated. In particular, the second fiber material (FM2) then does not comprise any component which is to be cured, for example a resin.

In this embodiment, the second fiber material (FM2) is preferably applied dry to at least part of the third structured surface (OS3) in step h).

The statements and preferences made/indicated above for the application of the first fiber material (FM1) to at least part of the first structured surface (OS1) in step d) apply analogously to the application of the second fiber material (FM2) to at least part of the third structured surface (OS3) in step h).

Preference is therefore given to the second fiber material (FM2) being applied to the entire third structured surface (OS3) of the fiber/foam composite (FSV1) in step h).

Preference is also given to the second fiber material (FM2) being applied by means of a calender in step h).

Furthermore, preference is given in the process of the invention to the second fiber material (FM2) being applied to a third structured surface (OS3) of the fiber-foam composite (FSV1) in step h), where the third structured surface (OS3) is oriented essentially parallel to the first structured fiber surface (FO1) of the intermediate (ZP) from step c).

For the purposes of the present invention, “essentially parallel” means that when a first equalizing plane is drawn through the third structured surface (OS3) and a second equalizing plane is drawn through the first structured fiber surface (FO1), these two equalizing planes are at an angle of not more than ±45°, preferably not more than ±30°, more preferably not more than ±10° and most preferably not more than ±2°, to one another.

The statements and preferences made/indicated above for the second foam body (SK2) provided in step d) apply analogously to the third foam body (SK3) provided in step i).

For the purposes of the present invention, the expression “a third foam body (SK3)” encompasses both precisely one third foam body (SK3) and also two or more third foam bodies (SK3), with preference being given to precisely one third foam body (SK3).

It is therefore preferred in the process of the invention that the third foam body (SK3) is provided in step i) by extrusion, thermoforming and/or wire cutting.

Furthermore, it is preferred in the process of the invention that the third foam body (SK3) provided in step i) comprises a thermoplastic polymer, preferably a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyimides, polyvinyl chlorides, polyolefins, polyacrylonitriles, polyether sulfides, copolymers and mixtures thereof.

The profile of the fourth structured surface (OS4) in step i) is preferably wave-shaped, zig-zag-shaped, diamond-shaped, lozenge-shaped, rectangular, square, point-like and/or grid-like.

Preference is also given to the fourth structured surface (OS4) of the third foam body (SK3) having the same dimensions as the second structured fiber surface (FO2) from step h).

The statements and preferences made/indicated above for the application of the second structured surface (OS2) of the second foam body (SK2) to the first structured fiber surface (FO1) in step e) apply analogously to the application of the fourth structured surface (OS4) of the third foam body (SK3) to the second structured fiber surface (FO2) in step j).

Preference is therefore given to the fourth structured surface (OS4) of the third foam body (SK3) and/or the second structured fiber surface (FO2) of the fiber-foam composite (FSV2) being heated by means of a heating element before step j) and thereby being joined to one another by a welding seam in the fiber-foam composite (FSV3) obtained in step j).

Furthermore, preference is given to an adhesive and/or a solvent being applied to the fourth structured surface (OS4) of the third foam body (SK3) and/or to the second structured fiber surface (FO2) of the fiber-foam composite (FSV2) before step j) and the fourth structured surface (OS4) of the third foam body (SK3) and the second structured fiber surface (FO2) of the fiber-foam composite (FSV2) being joined to one another by means of the adhesive and/or the solvent in the fiber-foam composite (FSV3) obtained in step j).

Preference is therefore given according to the invention to the fourth structured surface (OS4) of the third foam body (SK3) being joined to at least part of the second structured fiber surface (FO2) by adhesive bonding and/or by welding in the fiber-foam composite (FSV3) obtained in step j).

Furthermore, the fourth structured surface (OS4) of the third foam body (SK3) preferably completely covers the second structured fiber surface (FO2) after step j).

At least one resin is preferably applied to the second structured fiber surface (FO2) obtained in step h) after step h) and before step j).

All resins known to those skilled in the art are suitable as the at least one resin, with preference being given to a reactive thermoset or thermoplastic resin, more preferably a resin based on epoxides, acrylates, polyurethanes, polyamides, polyesters, unsaturated polyesters, vinyl esters or mixtures thereof. The resin is particularly preferably an aminacally curing epoxy resin, a latently curing epoxy resin, an anhydrically curing epoxy resin or a polyurethane derived from isocyanates and polyols. Such resin systems are known to those skilled in the art, for example from Penczek et al., “Advances in Polymer Science, 184, pp. 1-95, 2005”, Pham et al., “Ullmann's Encyclopedia of Industrial Chemistry, Vol. 13, 2012”, Fahler, “Polyamide Kunststoffhandbuch 3/4, 1998” and Younes “WO 12 134 878”.

The at least one resin can be cured after application and before step j). It is likewise possible for the at least one resin to be cured only after the fourth structured surface (OS4) of the third foam body (SK3) has been applied. Methods of curing the at least one resin are known to those skilled in the art.

It is possible for the fiber-foam composite (FSV3) obtained in step j) to be recirculated to step f). It goes without saying that the fiber-foam composite (FSV3) is used there instead of the fiber-foam composite (FSV1). Steps f) to j) can then be repeated at least once.

Preference is thus given in the process of the invention for the fiber-foam composite (FSV3) obtained in step j) to be recirculated to step f) and used there as fiber-foam composite (FSV1), whereupon the steps f) to j) are repeated at least once.

In addition, the following steps are preferably carried out after step j) in the process of the invention:
j-i) cutting of the fiber-foam composite (FSV3) obtained in step j) at least once at an angle in the range 0°≤α≤180° to the first fiber surface (FO1) to give a first cut fiber-foam composite having a first cut surface (OG1) and a second cut fiber-foam composite having a second cut surface (OG2),
j-ii) provision of a third fiber material (FM3),
j-iii) application of the third fiber material (FM3) to the first cut surface (OG1) of the first cut fiber-foam composite to give a third fiber surface (FO3),
j-iv) application of the second cut surface (OG2) of the second cut fiber-foam composite to the third fiber surface (FO3) to give a fiber-foam composite (FSV4) in which the second cut surface (OG2) is joined to the third fiber surface (FO3).

The statements and preferences made/indicated above for the steps e-i) to e-iv) apply analogously to the steps j-i) to j-iv).

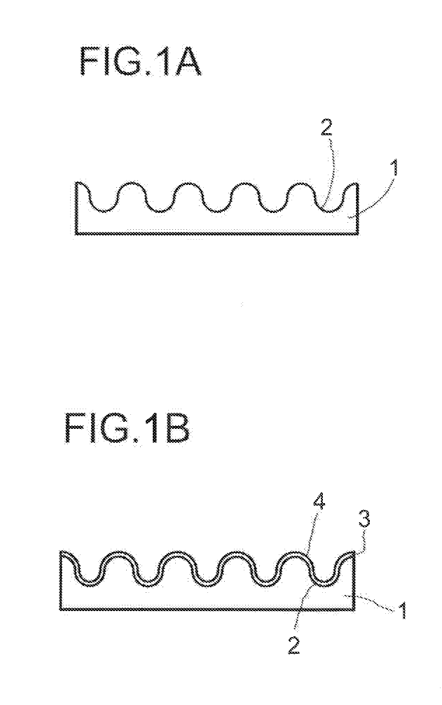

FIGS. 1A to 1D show by way of example an embodiment of the process for producing the fiber-foam composite (FSV1). In FIGS. 1A to 1D, identical reference numerals in each case have the same meaning.

FIG. 1A shows the first foam body (SK1; 1) which has a first structured surface (OS1; 2). A first fiber material (FM1; 3) is applied to this to give the first structured fiber surface (FO1; 4) which has the same profile as the first structured surface (OS1; 2) (FIG. 1B). In FIG. 1C, the second foam body (SK2; 5a) is provided. This has a second structured surface (OS2; 6) whose profile is inverse to the profile of the first structured fiber surface (FO1; 4). For the present purposes, “inverse” means that the profile of the second structured surface (052; 6) is the negative of the profile of the first structured fiber surface (FO1; 4). This means that, in each case viewed from the corresponding foam bodies, the second structured surface (OS2; 6) has depressions at the places at which the first structured fiber surface (FO1; 4) has raised regions, and vice versa.

FIG. 1D shows the fiber-foam composite (FSV1; 7) in which the first structured fiber surface (FO1; 4) and the second structured surface (OS2; 6) are joined to one another.

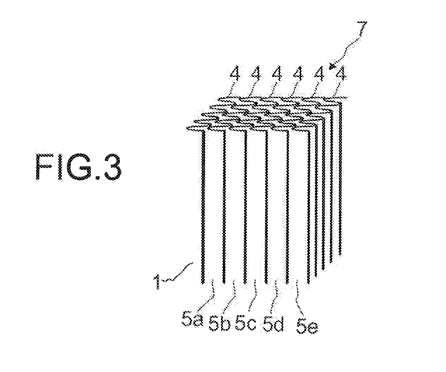

FIG. 3 shows an illustrative fiber-foam composite (FSV3; 7) which has been produced from a first foam body (SK1; 1) and five further foam bodies (SK2; SK3; 5a; 5b; 5c; 5d; 5e) and also a plurality of fiber materials 4. To produce the fiber-foam composite (FSV3), a fiber-foam composite (FSV1) was firstly produced by the process of the invention from a first foam body (SK1; 1), a first fiber material (FM1; 4) and a second foam body (SK2; 5a). A second fiber material (FM2; 4) was subsequently applied to the third structured surface (OS3) of the fiber-foam composite (FSV1), with the third structured surface (OS3) being essentially parallel to the first structured fiber surface (FO1). Finally, the third foam body (SK3; 5a) was applied. These steps were repeated four times.

1. A process for producing a fiber-foam composite (FSV1), which comprises the following steps:
a) of providing a first foam body (SK1) which has a first structured surface (OS1),
b) providing a first fiber material (FM1),
c) applying the first fiber material (FM1) to at least part of the first structured surface (OS1) of the first foam body (SK1) to give an intermediate (ZP) having a first structured fiber surface (FO1) which has the same profile as the first structured surface (OS1),
d) providing a second foam body (SK2) which has a second structured surface (OS2) whose profile is inverse to the profile of the first structured fiber surface (FO1) of the intermediate (ZP) and
e) applying the second structured surface (OS2) of the second foam body (SK2) to at least part of the first structured fiber surface (FO1) of the intermediate (ZP) to give the fiber-foam composite (FSV1) in which the first structured fiber surface (FO1) of the intermediate (ZP) and the second structured surface (OS2) of the second foam body (SK2) are joined to one another.

2. The process according to claim 1, wherein the following steps are carried out after step e):
f) providing the fiber-foam composite (FSV1) obtained in step e), where the fiber-foam composite (FSV1) has a third structured surface (OS3),
g) providing a second fiber material (FM2),
h) applying the second fiber material (FM2) to at least part of the third structured surface (OS3) of the fiber-foam composite (FSV1) to give a fiber-foam composite (FSV2) having a second structured fiber surface (FO2) which has the same profile as the third structured surface (OS3) of the fiber-foam composite (FSV1),
i) providing a third foam body (SK3) which has a fourth structured surface (OS4) whose profile is inverse to the profile of the second structured fiber surface (FO2) of the fiber-foam composite (FSV2) and
j) applying the fourth structured surface (OS4) of the third foam body (SK3) to at least part of the second structured fiber surface (FO2) to give a fiber-foam composite (FSV3) in which the second structured fiber surface (FO2) of the fiber-foam composite (FSV2) and the fourth structured surface (OS4) of the third foam body (SK3) are joined to one another.

3. The process according to claim 2, wherein
I) the fiber-foam composite (FSV3) obtained in step j) is recirculated to step f) and used there as fiber-foam composite (FSV1), whereupon the steps 1) to j) are repeated at least once, and/or
II) the second fiber material (FM2) is applied to a third structured surface (OS3) of the fiber-foam composite (FSV1) in step h), with the third structured surface (OS3) being oriented essentially parallel to the first structured fiber surface (FO1) of the intermediate (ZP) from step c), and/or
III) the first foam body (SK1) has the third structured surface (OS3), with the third structured surface (OS3) being arranged opposite the first structured surface (OS1), and/or
IV) the second foam body (SK2) has the third structured surface (OS3), with the third structured surface (OS3) being arranged opposite the second structured surface (OS2).

4. The process according to any of claims 1 to 3claim 1, wherein
I) the first fiber material (FM1) is applied to the entire first structured surface (OS1) of the first foam body (SK1) in step c), and/or
II) the second fiber material (FM2) is applied to the entire third structured surface (OS3) of the fiber-foam composite (FSV1) in step h).

5. The process according to claim 1, wherein
I) the first structured fiber surface (FO1) from step c) has the same dimensions as the second structured surface (OS2) of the second foam body (SK2), and/or
II) the second structured surface (OS2) of the second foam body (SK2) completely covers the first structured fiber surface (FO1) after step e), and/or
III) the fourth structured surface (OS4) of the third foam body (SK3) has the same dimensions as the second structured fiber surface (FO2) from step h), and/or
IV) the fourth structured surface (OS4) of the third foam body (SK3) completely covers the second structured fiber surface (FO2) after step j).

6. The process according to claim 1, wherein
I) the first fiber material (FM1) is applied by means of a calender in step c), and/or
II) the second fiber material (FM2) is applied by means of a calender in step h).

7. The process according to claim 1, wherein
I) at least step a) and step c) are carried out in direct succession, and/or
II) at least step a) and step c) are carried out continuously.

8. The process according to claim 1, wherein
I) the second structured surface (OS2) of the second foam body (SK2) is joined to at least part of the first structured fiber surface (FO1) by adhesive bonding and/or welding in the fiber-foam composite (FSV1) obtained in step e), and/or
II) the fourth structured surface (OS4) of the third foam body (SK3) is joined to at least part of the second structured fiber surface (FO2) by adhesive bonding and/or welding in the fiber-foam composite (FSV3) obtained in step j), and/or
III) the second structured surface (OS2) of the second foam body (SK2) and/or the first structured fiber surface (FO1) of the intermediate (ZP) are heated by means of a heating element before step e) and are thereby joined to one another by a welding seam in the fiber-foam composite (FSV1) obtained in step e), and/or
IV) the fourth structured surface (OS4) of the third foam body (SK3) and/or the second structured fiber surface (FO2) of the fiber-foam composite (FSV2) are heated by means of a heating element before step j) and thereby joined to one another by a welding seam in the fiber-foam composite (FSV3) obtained in step j), and/or
V) an adhesive and/or a solvent is applied to the second structured surface (OS2) of the second foam body (SK2) and/or to the first structured fiber surface (FO1) of the intermediate (ZP) before step e) and the second structured surface (OS2) of the second foam body (SK2) and the first structured fiber surface (FO1) of the intermediate (ZP) are joined to one another by means of the adhesive and/or the solvent in the fiber-foam composite (FSV1) obtained in step e), and/or
VI) an adhesive and/or a solvent is applied to the fourth structured surface (OS4) of the third foam body (SK3) and/or to the second structured fiber surface (FO2) of the fiber-foam composite (FSV2) before step j) and the fourth structured surface (OS4) of the third foam body (SK3) and the second structured fiber surface (FO2) of the fiber-foam composite (FSV3) are joined to one another by means of the adhesive and/or the solvent in the fiber-foam composite (FSV3) obtained in step j).

9. The process according to claim 1, wherein
I) the first foam body (SK1) is provided in step a) by extrusion, thermoforming and/or wire cutting, and/or
II) the second foam body (SK2) is provided in step d) by extrusion, thermoforming and/or wire cutting, and/or
III) the third foam body (SK3) is provided in step i) by extrusion, thermoforming and/or wire cutting.

10. The process according to claim 1, wherein
I) the profile of the first structured surface (OS1) in step a) is wave-shaped, zig-zag-shaped, diamond-shaped, lozenge-shaped, rectangular, square, point-like and/or grid-like, and/or
II) the profile of the second structured surface (OS2) in step d) is wave-shaped, zig-zag-shaped, diamond-shaped, lozenge-shaped, rectangular, square, point-like and/or grid-like, and/or
III) the profile of the third structured surface (OS3) in step f) is wave-shaped, zig-zag-shaped, diamond-shaped, lozenge-shaped, rectangular, square, point-like and/or grid-like, and/or
IV) the profile of the fourth structured surface (OS4) in step i) is wave-shaped, zig-zag-shaped, diamond-shaped, lozenge-shaped, rectangular, square, point-like and/or grid-like.

11. The process according to claim 1, wherein
I) the first fiber material (FM1) provided in step b) is selected from the group consisting of inorganic mineral fibers, organic fibers, natural polymers, natural organic fibers of vegetable or animal origin, carbon fibers and mixtures thereof, preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof, and/or
II) the first fiber material (FM1) is provided in step b) as woven fabric, lay-up, braid, nonwoven, organosheet, carded band and/or roving, and/or
III) the first fiber material (FM1) provided in step b) comprises a size, and/or
IV) the first fiber material (FM1) provided in step b) comprises a matrix material, a binder, thermoplastic fibers, powders and/or particles.

12. The process according to claim 1, wherein
I) the second fiber material (FM2) provided in step g) is selected from the group consisting of inorganic mineral fibers, organic fibers, natural polymers, natural organic fibers of vegetable or animal origin, carbon fibers and mixtures thereof, preferably selected from the group consisting of glass fibers, basalt fibers, metal fibers, ceramic fibers, nanotube fibers, polycondensation fibers, polyaddition fibers, cellulose-based fibers, rubber fibers, starch-based fibers, glucose-based fibers and mixtures thereof, and/or
II) the second fiber material (FM2) is provided in step g) as woven fabric, lay-up, braid, nonwoven, organosheet, carded band and/or roving, and/or
III) the second fiber material (FM2) provided in step g) comprises a size, and/or
IV) the second fiber material (FM2) provided in step g) comprises a matrix material, a binder, thermoplastic fibers, powders and/or particles.

13. The process according to claim 1, wherein
I) the first foam body (SK1) provided in step a) comprises a thermoplastic polymer, preferably a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyimides, polyvinyl chlorides, polyolefins, polyacrylonitriles, polyether sulfides, copolymers and mixtures thereof, and/or
II) the second foam body (SK2) provided in step d) comprises a thermoplastic polymer, preferably a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyimides, polyvinyl chlorides, polyolefins, polyacrylonitriles, polyether sulfides, copolymers and mixtures thereof, and/or
III) the third foam body (SK3) provided in step i) comprises a thermoplastic polymer, preferably a thermoplastic polymer selected from the group consisting of thermoplastic elastomers, thermoplastic elastomers having a copolymer structure, polyetheramides, polyether esters, polyurethanes, styrene polymers, polyacrylates, polycarbonates, polyesters, polyethers, polyamides, polyether sulfones, polyether ketones, polyimides, polyvinyl chlorides, polyolefins, polyacrylonitriles, polyether sulfides, copolymers and mixtures thereof.

14. The process according to claim 1, wherein the following steps are carried out after step e):
e-i) cutting of the fiber-foam composite (FSV1) obtained in step e) at least once at an angle in the range 0°<α<180° to the first fiber surface (FO1) to give a first cut fiber-foam composite having a first cut surface (OG1) and a second cut fiber-foam composite having a second cut surface (OG2),
e-ii) providing a third fiber material (FM3),
e-iii) applying the third fiber material (FM3) to the first cut surface (OG1) of the first cut fiber-foam composite obtained in step e-i) to give a third fiber surface (FO3),
e-iv) applying the second cut surface (OG2) of the second cut fiber-foam composite obtained in step e-i) to the third fiber surface (FO3) to give a fiber-foam composite (FSV4) in which the second cut surface (OG2) is joined to the third fiber surface (FO3).

15. The process according to claim 1, wherein the following steps are carried out after step j):
j-i) cutting of the fiber-foam composite (FSV3) obtained in step j) at least once at an angle in the range 0°<α<180° to the first fiber surface (FO1) to give a first cut fiber-foam composite having a first cut surface (OG1) and a second cut fiber-foam composite having a second cut surface (OG2),
j-ii) providing a third fiber material (FM3),
j-iii) applying the third fiber material (FM3) to the first cut surface (OG1) of the first cut fiber-foam composite to give a third fiber surface (FO3),
j-iv) applying the second cut surface (OG2) of the second cut fiber-foam composite to the third fiber surface (FO3) to give a fiber-foam composite (FSV4) in which the second cut surface (OG2) is joined to the third fiber surface (FO3).
